(19) United States
(12) Patent Application Publication
(10) Pub. No.: US 2003/0030647 A1
(43) Pub. Date: Feb. 13, 2003

(54) Flexible method and apparatus for dithering image data

(76) Inventor: Atsushi Togami, Kanagawa (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/100,711

(22) Filed: Mar. 19, 2002

(30) Foreign Application Priority Data
Mar. 21, 2001 (JP) 2001-079617

(51) Int. Cl. G09G 5/00

(52) U.S. Cl. 345/586

(57) ABSTRACT

The flexible method and apparatus for dithering image data independently specify the output image data size in a number of bits as well as the dither size in the running and sub-running directions. The input image data is processed based upon the above determined parameters in a common piece of hardware without redesigning associated circuits.

### FIELD OF THE INVENTION

The current invention is generally related to dithering in image processing, and more particularly related to.

### BACKGROUND OF THE INVENTION

To compensate for the instability in an image forming apparatus such as a printer and a printer using the electrophotography process, error diffusion and or dithering methods generally have been applied to output image data. Among the above intermediate processing steps, multi-value dithering has been currently used. Furthermore, as the resolution of the printer engine/scanner has improved, dithering has increased its size while it has decreased a number of values. The above tendency for a smaller number of values is more apparent for low-end machines. One reason for the relation between the low-end machines and a small number of values in dithering is that the small value is preferred for simple control and low associated costs thanks to the high resolution. On the other hand, since the devices used for DTP and design applications require a high level of image quality, a large number of values has been still used in dithering. To summarize the current status, it is a transition from the multi-value low resolution dithering to the small-value high resolution dithering, and depending upon the applications, different levels of the multi-value dithering coexist with the small-value high resolution dithering.

Due to the above described trend, the product development cycle has been shortened among the manufacturers. It is extremely inefficient to design and manufacture separate hardware for the various dithering methods. Although it is desirable to implement hardware that universally processes various dithering processes, the hardware system will be redundant. To avoid the redundancy, a memory is designed to be shared for storing dithering patterns in medium processing circuits. Some of the above described prior art technologies are disclosed in Japanese Patent Publication 2000-32264. For eight-bit and four-bit data, a corresponding dithering size is fixed at 8×8. Similarly, for one-bit or two-bit data, a corresponding dithering size is fixed at 16×16. In the same prior art, memory is commonly used for converting the addresses and switching the data buses so as to avoid the enlarged circuit size. In summary, the above described technology switches the output performance by using a different number of bits in dithering depending upon user needs.

Despite the above described prior art technology, a flexibility for dithering remains relatively low when a dithering size changes. For example, when the writing density changes from 600 dpi to 1200 dpi in both the main and sub running directions, the dithering size at least needs to be quadrupled since the size must be doubled in the both directions. However, when the dithering size changes, it is necessary to redesign the circuit. Furthermore, a number of writing bits changes, the dithering pattern also changes. For the above reasons, a low degree of flexibility remains for a dithering size change. Thus, it remains desirable to have a dithering circuit that has a high degree of flexibility in accommodating various dithering sizes, various writing densities and a various number of bits.

### SUMMARY OF THE INVENTION

In order to solve the above and other problems, according to a first aspect of the current invention, a method of dithering image data, including the steps of: storing dithering data in memory in a predetermined manner; specifying an output data bit size in a number of bits per pixel for output data; specifying a dither size of a dither matrix in a second number in a running direction times a third number in a sub-running direction, the dither size being independent of the output data; inputting input image data having an input data bit size in a number of bits per pixel; determining an address offset into the table based upon the output data bit size and the dither size; adjusting the address offset based upon the output data bit size; obtaining a relevant portion of the dithering data from the memory based upon the address offset; and adjusting the relevant portion of the dithering data based upon the output data bit size and the input data to generate adjusted dithering data.

According to a second aspect of the current invention, a storage medium containing computer executable instructions to perform tasks of dithering image data, including the tasks of: storing dithering data in memory in a predetermined manner;

specifying an output data bit size in a number of bits per pixel for output data; specifying a dither size of a dither matrix in a second number in a running direction times a third number in a sub-running direction, the dither size being independent of the output data; inputting input image data having an input data bit size in a number of bits per pixel; determining an address offset into the table based upon the output data bit size and the dither size; adjusting the address offset based upon the output data bit size; obtaining a relevant portion of the dithering data from the memory based upon the address offset; and adjusting the relevant portion of the dithering data based upon the output data bit size and the input data to generate adjusted dithering data.

According to a third aspect of the current invention, an image processing device for dithering image data, including: a data storage unit for storing dithering data in memory in a predetermined manner; a first temporary memory unit for specifying an output data bit size in a number of bits per pixel for output data; a second temporary memory unit for specifying a dither size of a dither matrix in a second number in a running direction times a third number in a sub-running direction, the dither size being independent of the output data; a third temporary memory unit operationally connected to the second temporary memory unit for inputting input image data having an input data bit size in a number of bits per pixel; an address offset determination unit operationally connected to the data storage unit and for determining an address offset into the table based upon the output data bit size and the dither size, the address offset determination unit adjusting the address offset based upon the output data bit size; and a dithering data selection unit operationally connected to the first temporary memory unit, the third temporary memory unit, the address offset determination unit and the data storage unit for obtaining a relevant portion of the dithering data from the memory based upon the address offset, the dithering data selection unit adjusting the relevant portion of the dithering data based upon the output data bit size and the input data to generate adjusted dithering data.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of the image processing circuit according to the current invention.

FIG. 2, a table illustrates an exemplary output image data.

FIG. 3 is a diagram illustrates an exemplary table that stores 8-bit values according to the 256 gradations that correspond to the maximal of 128 elements in the dither matrix.

FIG. 4 is a table illustrating second exemplary output image data.

FIG. 5 is a diagram illustrating an exemplary table that stores 4-bit values according to the 256 gradations that correspond to the maximal of 128 elements in the dither matrix.

FIG. 6 is a table illustrates third exemplary output image data.

FIG. 7 is a diagram illustrating an exemplary table that stores 2-bit values according to the 256 gradations that correspond to the maximal of 256 elements in the dither matrix.

FIG. 8 is a block diagram illustrating a second preferred embodiment of the image processing circuit according to the current invention.

FIG. 9 is a diagram illustrating an exemplary content of a table which specifies an arbitrary value to be placed in the bit shift setting register in the second preferred embodiment according to the current invention.

FIG. 10 is a block diagram illustrating a third preferred embodiment of the image processing circuit according to the current invention.

FIG. 11 is a table illustrating exemplary conversion data to be used by the third preferred embodiment of the image processing according to the current invention.

FIG. 12 is a block diagram illustrating a fourth preferred embodiment of the image processing circuit according to the current invention.

FIG. 13 is a block diagram illustrating a fifth preferred embodiment of the image processing circuit according to the current invention.

FIG. 14 is a flow chart illustrating steps involved in a preferred process of dithering image data according to the current invention.

### DETAILED DESCRIPTION OF THE PREFERRED EMBODIMENT(S)

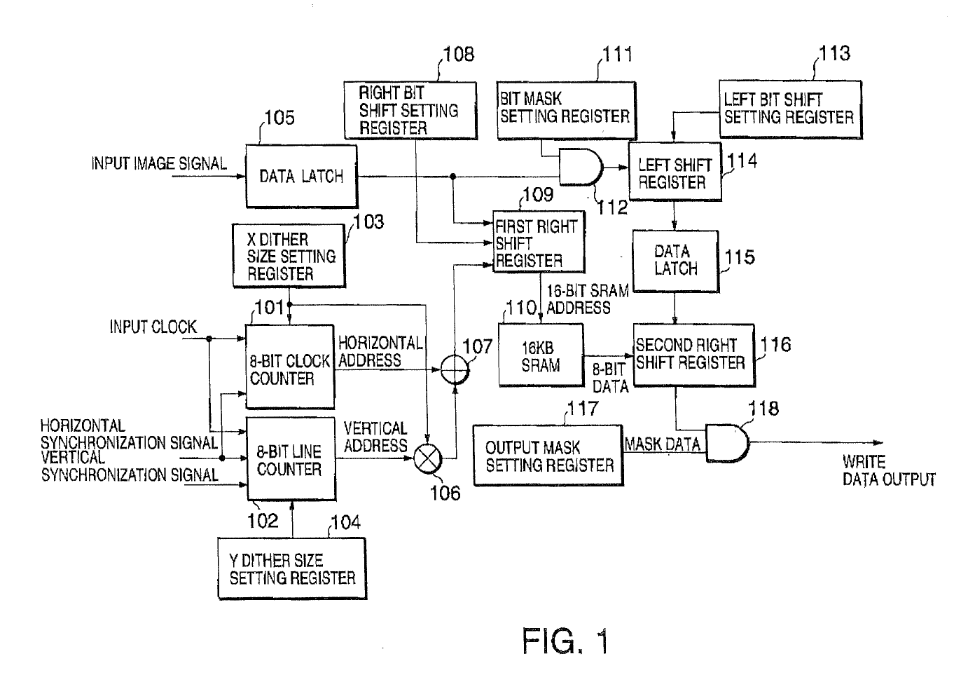

Referring now to the drawings, wherein like reference numerals designate corresponding structures throughout the views, and referring in particular to FIG. 1, a block diagram illustrates one preferred embodiment of the image processing circuit according to the current invention. In general, the preferred embodiment processes multiple input signal sizes to generate multiple output signal sizes based upon a predetermined set of dithering sizes. For example, the preferred embodiment processes an 8-bit input image signal to generate an 8-bit output signal based upon an s8×t8 dithering size (≦64). Similarly, the same preferred embodiment processes a 4-bit input image signal to generate a 4-bit output signal based upon a s4×t4 dithering size (≦128) while the same hardware also processes a 2-bit input image signal to generate a 2-bit output signal based upon a s2×t2 dithering size (≦256). It is also possible for the preferred embodiment to process a 1-bit input image signal to generate a 1-bit output signal based upon a s1×t1 dithering size (≦512, s1≦256, t1≦256). In the above example, one dithering size is an s8×t8 (≦64), it is not limited to this size. When the input signal is 16-bit and the dithering size is 16-bit, the preferred embodiment processes a plurality of output bits including a 8-bit dithering size, a 4-bit dithering size, 2-bit dithering size and a single-bit dithering size. By the same token, although the dither size is shown as x and y sizes in 8-bit with 64 being the limit, a larger size is accommodated by changing the composition.

Still referring to FIG. 1, the preferred embodiment includes the following components or units that function in a predetermined manner. The preferred embodiment includes a 8-bit clock counter 101, a 8-bit line counter 102, a X dither size setting register 103, a Y dither size setting register 104, a data latch 105, a multiplier 106, an adder 107, a right bit shift setting register 108, a first right shift register 109, a 16 KB SRAM 110, a bit mask setting register 111, a logical AND gate 112, a left bit shift setting register 113, a left shift register 114, a data latch 115, a second right shift register 116, an output mask setting register 117 and a logical AND gate 118.

Assuming that the output image signal is 8-bit and the dither size is 8×6 as shown in FIG. 2, the 8-bit clock counter 101 and the 8-bit line counter 102 each receive an input clock signal and a horizontal synchronization signal. A number of bits in the output image data or signal is synonymously used with the output data bit size. The 8-bit line counter 102 further receives a vertical synchronization signal. Although the 8-bit clock counter 101 and the 8-bit line counter 102 each counts up to 256 or a number corresponding to eight bits, the maximal number is set respectively set by the X dither size setting register 103 and the Y dither size setting register 104. According to the above assumed dither size, the X dither size setting register 103 and the Y dither size setting register 104 respectively store the X dither size of 8 and the Y dither size of 6. Based upon the above values, the 8-bit clock counter 101 functions to count eight clock signals while the 8-bit line counter 102 functions to count six clock signals. The output is used as a horizontal address and a vertical address in the dither matrix. The multiplier 106 multiplies the output from the line counter 102 by a value in the X dither size setting register 103, and the value above example is eight. The adder 107 adds the above product and the output from the 8-bit clock counter 101. The output from the adder 107 is a 16-bit output since the adder 107 an output from the multiplier 106, which performs 8-bit×8-bit multiplications.

Still referring to FIG. 1, concurrently with the above described operations, the input image data is latched in the data latch 105 by the clock signal from the above two counters. The 8-bit image output from the data latch 105 is placed in the low 8 bits while the 16-bit dither matrix address offset from the adder 107 is placed in the upper 16 bits. The above combined 24-bit data is inputted into the right shift register 109. The right shift register 109 right shifts the inputted data by a value stored in the right bit shift setting register 108. The right shift setting register 108 stores one of the following values depending upon the output image signal.

| A number of bits in the | Amount of right |
|---|---|
| output image signal: | shift: |
| 8 | 0 |
| 4 | 1 |
| 2 | 2 |
| 1 | 3 |

Since the output image data is 8 bit, the amount of shift, zero is initially set. The right shift register 109 does not perform the 24-bit data shift. Since the bus address to the SRAM 110 is 14-bit, the upper 10 bits are thrown away and the lower 14 bits are used as an address. The SRAM 110 having 16 K-bit storage capacity stores 8-bit or 256 gradation values for 64 elements in a maximal dithering matrix. 8-bit dither data is read from the SRAM address and is outputted into the second right shift register 116. The 8-bit dither data corresponds to the 14-bit data from the right shift register 109. The second right shift register 116 shifts the 8-bit dither data to the right by a number of bits in the input image data and the output image data. The above amount of shift is determined by masking unnecessary data after the logical AND gate 112 performs the logical AND operation on a bit mask value in the bit mask setting register 111 and a delay-corrected input image signal from the data latch 105. The input image signal is also inputted into the first right shift register 109.

In the bit mask setting register 111, one of the following values is stored depending upon the number of bits in the output image signal.

| A number of bits in the | |
|---|---|
| output image signal: | Bit Mask values: |
| 8 | 0 x 00 |
| 4 | 0 x 01 |
| 2 | 0 x 03 |
| 1 | 0 x 07 |

For example, when the number of bits in the output image signal is eight, the bit mask value is 0×00 according to the above table. Because of the all-zero bit mask value, no matter what image data is inputted, every bit is masked with 0 when the number of bits is eight.

The left shift register 114 left shifts the output from the logical AND gate 112 by a value that is stored in the left bit shift setting register 113. Like the above bit mask setting register 111 and right bit shift setting register 108, in the left bit shift setting register 113, one of the following values is stored depending upon the number of bits in the output image signal.

| A number of bits in the | Amount of left |
|---|---|
| output image signal: | shift: |
| 8 | 0 x 03 |
| 4 | 0 x 02 |
| 2 | 0 x 01 |
| 1 | 0 x 00 |

For example, when the number of bits in the output image signal is eight, the left shift value in the left bit shift setting register 113 is 0×03 according to the above table. However, since the above logical AND gate 112 masks every bit, even though the image data is shifted by three, there is no change in the output from the left shift register 114. Finally, the data latch 115 corrects delay on the output from the left shift register 114, and the image data is outputted to the second right shift register 116. The right shift amount is thus determined for the second right shift register 116 that receives the 8-bit data from the SRAM 110. Since the right shift amount is zero for the 8-bit, the 8-bit output from the SRAM 110 is outputted to the AND gate 118 without any process.

The AND gate 118 masks the output from the second right shift register 116 based upon the mask setting from the output mask setting register 117. The output mask setting register 117 stores the following values based upon a number of bits in the output image data.

| A number of bits in the | |
|---|---|
| output image signal: | Bit mask values: |
| 8 | 0 x ff |
| 4 | 0 x 0f |
| 2 | 0 x 03 |
| 1 | 0 x 01 |

For example, when the number of bits in the output image signal is eight, the corresponding mask value is 0×ff. In other words, every bit is valid and will be used when the output signal has eight bits. The 8-bit data will be outputted from the preferred embodiment of the image processing device according to the current invention.

Now referring to FIG. 2, a table illustrates an exemplary output image data. In the output image signal, every pixel is represented by 8-bit data, and the signal has a dither size of 8×6 As described above with respect to FIG. 1, the adder 107 and the multiplier 106 determine an offset address. As shown in FIG. 2, when a position in the main running direction is 5 while that in the sub running direction is 2, the result from the adder 107 and the multiplier 106 results in 21 as 8 times 2 plus 5 equals 21. The output points to a 21^{st} element in the dither matrix and is used as an offset in the SRAM 110.

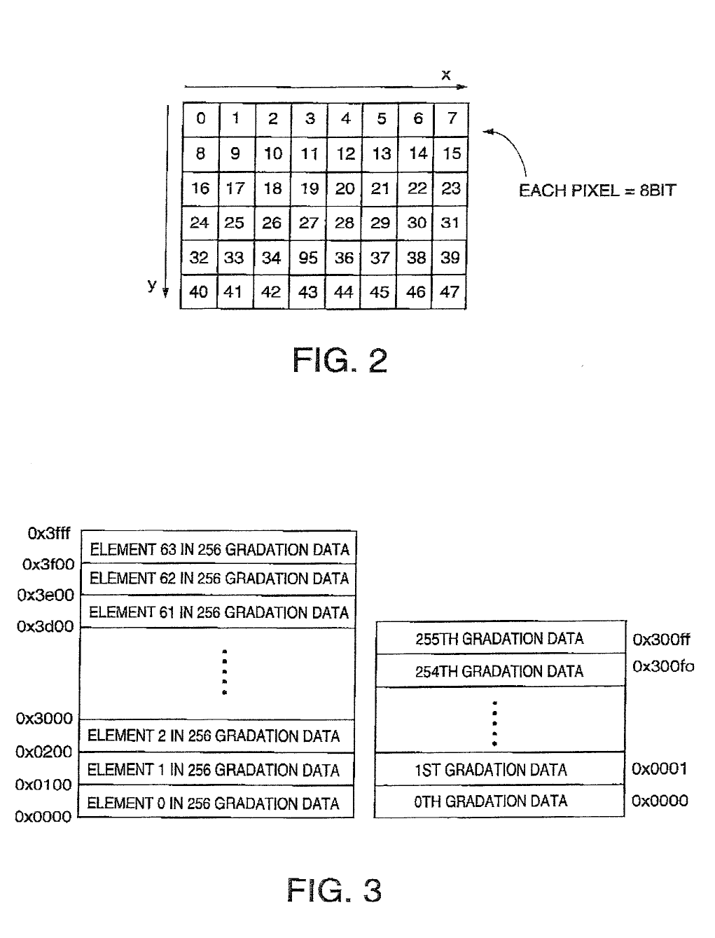

Referring to FIG. 3, a diagram illustrates an exemplary table that stores 8-bit values according to the 256 gradations that correspond to the maximal of 128 elements in the dither matrix. At each address, 8-bit data is stored for dithering data foe each gradation.

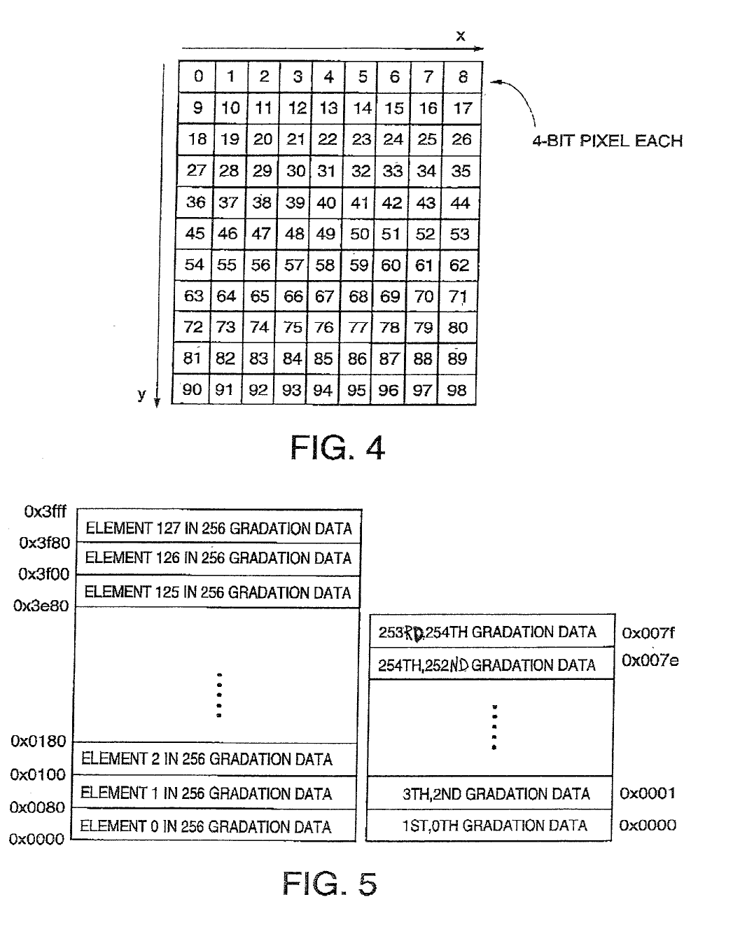

Now referring to FIG. 4, a table illustrates second exemplary output image data. In the output image signal, every pixel is represented by 4-bit data, and the signal has a dither size of 9×11. Assuming that the output image signal is 4-bit and the dither size is 9×11 as shown in FIG. 4, the following will be described with respect to the units or components as shown in FIG. 1.

Referring back to FIG. 1, the 8-bit clock counter 101 and the 8-bit line counter 102 each receive an input clock signal and a horizontal synchronization signal. The 8-bit line counter 102 further receives a vertical synchronization signal. Although the 8-bit clock counter 101 and the 8-bit line counter 102 each counts up to 256 or a number corresponding to eight bits, the maximal number is set respectively set by the X dither size setting register 103 and the Y dither size setting register 104. According to the above assumed dither size, the X dither size setting register 103 and the Y dither size setting register 104 respectively store the X dither size of 9 and the Y dither size of 11. Based upon the above values, the 8-bit clock counter 101 functions to count nine clock signals while the 8-bit line counter 102 functions to count eleven clock signals. The output is used as a horizontal address and a vertical address in the dither matrix. The multiplier 106 multiplies the output from the line counter 102 by the value in the X dither size setting register 103, and the value in the above example is nine. The adder 107 adds the above product and the output from the 8-bit clock counter 101. When a position in the main running direction is 5 while that in the sub running direction is 5, the result from the adder and the multiplier 106 results in 50 as 5 times 9 plus 5 equals 50. The output points to a 50^{th} element in the dither matrix and is used as an offset in the SRAM 110.

Still referring to FIG. 1 with the above second exemplary image data, the input image data is latched in the data latch 105 by the clock signal from the above two counters. The 8-bit image output from the data latch 105 is placed in the lower 8 bits while the 16-bit dither matrix address offset from the adder 107 is placed in the upper 16 bits. The above combined 24-bit data is inputted into the right shift register 109. The right shift register 109 right shifts the inputted data by a value stored in the right bit shift setting register 108. By the above shift, the address to be outputted in the SRAM 110 is 14 bits after the upper nine bits and the lowest single bit have been removed from the 24-bit data. The 16KB SRAM 110 stores 4-bit values according to the 256 gradations that correspond to the maximal of 128 elements in the dither matrix.

Referring to FIG. 5, a diagram illustrates an exemplary table that stores 4-bit values according to the 256 gradations that correspond to the maximal of 128 elements in the dither matrix. At each address, 8-bit data is stored for dithering data. That is, if it is 4-bit data, there are data for two gradations at a single address. The dithering data for the two gradations is a pair of continuous two gradations. The dithering data for the lower gradation is stored in the lower four bits while that for the higher gradation is stored in the upper four bits.

With respect to FIG. 1, the 4-bit dither data for the two gradations is read from the address in the SRAM 110, which corresponds to the 14-bit address data from the right shift register 109. The 4-bit dither data is outputted to the second right shift register 116. The second right shift register 116 shits the 4-bit two-gradation dither data to the right base upon the number of bits in the input image data or the output image data. The amount of the right shift is determined in a similar manner as in the case of the 8-bit data. First, the logical AND gate 112 performs the logical AND operation on a bit mask value in the bit mask setting register 111 and a delay-corrected input image signal from the data latch 105, which is also inputted into the right shift register 109. The above logic AND operation masks data except for the necessary data. When the output image signal is 4-bit, as described above, since the bit mask setting register 111 is set to 0×01, the logical AND gate 112 only validates the lowest bit of the input image data.

The left shift register 114 shifts the output from the logical AND gate 112 that contains valid data in the lowest bit to the left by 0×02 that is stored in the left bit shift setting register 113. The output from the left shift register 114 is divided into the following two.

| Input data | Output data |
|---|---|
| 0 x 00 | 0 x 00 |
| 0 x 01 | 0 x 04 |

After one of the above two outputs is latched in the data latch 115, the output is used as an amount for the right shift for the second right shift register 116. When the right shift amount is 0×00, the 4-bit two-gradation image data is outputted to the logical AND gate 118. For an 4-bit output, the setting value is 0×0f in the output mask setting register 117, and it masks the upper four bits to generate the 4-bit image output data. Furthermore, when the right shift amount is 0×04, the 4-bit two-gradation image data is shifted to the right by four bits, and the upper four bits are sent to the lower bit positions. The result is outputted to the logical AND gate 118. Similarly, after the upper four bits are masked by the value, 0×0f, the result is outputted.

As described above, by dividing the single 8-bit data to store the two gradations for the 4-bit outputs, the SRAM 110 maintains the address space in 14-bit, and the SRAM 110 is shared. A pair of 4-bit data is stored in the upper and lower portions of the 8-bit space, and the lowest bit of the 8-bit input image data indicates either of the pair of the 4-bit data. As a result, since one bit is saved in the SRAM addressing, a number of elements in dithering for the 4-bit data is doubled from that for the 8-bit data.

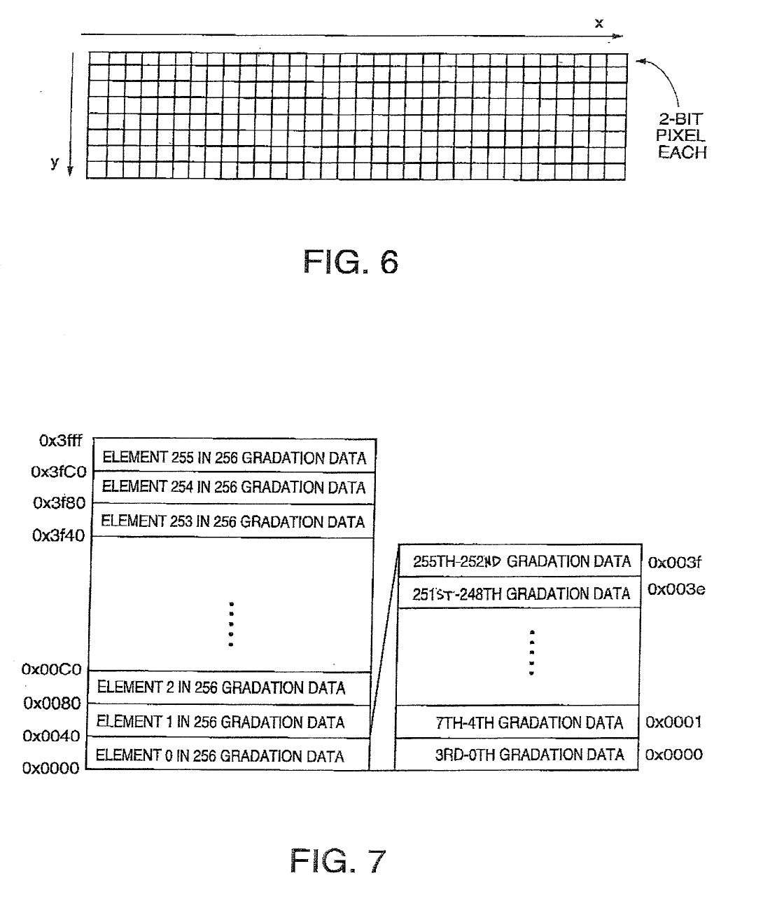

Now referring to FIG. 6, a table illustrates third exemplary output image data. In the output image signal, every pixel is represented by 2-bit data, and the signal has a dither size of 32×8. Assuming that the output image signal is 2-bit and the dither size is 32×8 as shown in FIG. 6, the following will be described with respect to the units or components as shown in FIG. 1.

Referring back to FIG. 1, the 8-bit clock counter 101 and the 8-bit line counter 102 each receive an input clock signal and a horizontal synchronization signal. The 8-bit line counter 102 further receives a vertical synchronization signal. Although the 8-bit clock counter 101 and the 8-bit line counter 102 each counts up to 256 or a number corresponding to eight bits, the maximal number is set respectively set by the X dither size setting register 103 and the Y dither size setting register 104. According to the above assumed dither size, the X dither size setting register 103 and the Y dither size setting register 104 respectively store the X dither size of 32 and the Y dither size of 8. Based upon the above values, the 8-bit clock counter 101 functions to count thirty-two clock signals while the 8-bit line counter 102 functions to count eight clock signals. The output is used as a horizontal address and a vertical address in the dither matrix. The multiplier 106 multiplies the output from the line counter 102 by the value in the X dither size setting register 103, and the value in the above example is nine. The adder 107 adds the above product and the output from the 8-bit clock counter 101.

Still referring to FIG. 1 with the above second exemplary image data, the input image data is latched in the data latch 105 by the clock signal from the above two counters. The 8-bit image output from the data latch 105 is placed in the lower 8 bits while the 16-bit dither matrix address offset from the adder 107 is placed in the upper 16 bits. The above combined 24-bit data is inputted into the right shift register 109. The right shift register 109 right shifts the inputted data by two, a value stored in the right bit shift setting register 108. By the above shift by two bits, the address to be outputted in the SRAM 110 is 14 bits after the upper ten bits and the lower two bit have been removed from the 24-bit data. The 16 KB SRAM 110 stores 2-bit values according to the 256 gradations that correspond to the maximal of 256 elements in the dither matrix.

Referring to FIG. 7, a diagram illustrates an exemplary table that stores 2-bit values according to the 256 gradations that correspond to the maximal of 256 elements in the dither matrix. At each address, 8-bit data is stored for dithering data. That is, if it is 2-bit data, there are data for four gradations at a single address. The dithering data for the four gradations is four continuous gradations. The dithering data for the lowest gradation is stored in the lowest two bits while that for the highest gradation is stored in the most upper two bits.

With respect to FIG. 1, the 2-bit dither data for the four gradations is read from the address in the SRAM 110, which corresponds to the 14-bit address data from the right shift register 109. The 2-bit dither data is outputted to the second right shift register 116. The second right shift register 116 shits the 2-bit four-gradation dither data to the right base upon the number of bits in the input image data or the output image data. The amount of the right shift is determined in a similar manner as in the case of the 8-bit data and the 4-bit data. First, the logical AND gate 112 performs the logical AND operation on a bit mask value in the bit mask setting register 111 and a delay-corrected input image signal from the data latch 105, which is also inputted into the right shift register 109. The above logic AND operation masks data except for the necessary data. When the output image signal is 2-bit, as described above, since the bit mask setting register 111 is set to 0×03, the logical AND gate 112 only validates the lowest two bits of the input image data.

The left shift register 114 shifts the output from the logical AND gate 112 that contains valid data in the lowest two bits to the left by 0×01 that is stored in the left bit shift setting register 113. The output from the left shift register 114 is divided into the following four.

| Input data | Output data |
|---|---|
| 0 x 00 | 0 x 00 |
| 0 x 01 | 0 x 02 |
| 0 x 02 | 0 x 04 |
| 0 x 03 | 0 x 06 |

After one of the above two outputs is latched in the data latch 115, the output is used as an amount for the right shift for the second right shift register 116. When the right shift amount is 0×00, the 2-bit four-gradation image data is outputted to the logical AND gate 118. For an 2-bit output, the setting value is 0×03 in the output mask setting register 117, and it masks the upper six bits to generate the 2-bit image output data. Furthermore, when the right shift amount is 0×02, the 2-bit four-gradation image data is shifted to the right by two bits, and the upper six bits are shifted to the lower bit positions. The result is outputted to the logical AND gate 118. Similarly, after the upper six bits are masked by the value, 0×03, the 2-bit data is outputted. When the right shift amount is 0×04 and 0×06, the similar operations are performed.

As described above, by dividing the single 8-bit data to store the four gradations for the 2-bit outputs, the SRAM 110 maintains the address space in 14-bit, and the SRAM 110 is shared. A set of four 2-bit data is stored in the upper and lower portions of the 8-bit space, and the lowest two bits of the 8-bit input image data indicate one of the four 2-bit data. As a result, since two bits are saved in the SRAM addressing, a number of elements in dithering for the 2-bit data is quadrupled from that of the 8-bit data.

In fourth exemplary output image data, every pixel is represented by 1-bit data. By the same token, a number of elements in dithering for the 1-bit data is eight times from that of the 8-bit data. The number of elements for the 1-bit data is 512 while that for the 8-bit data is 64.

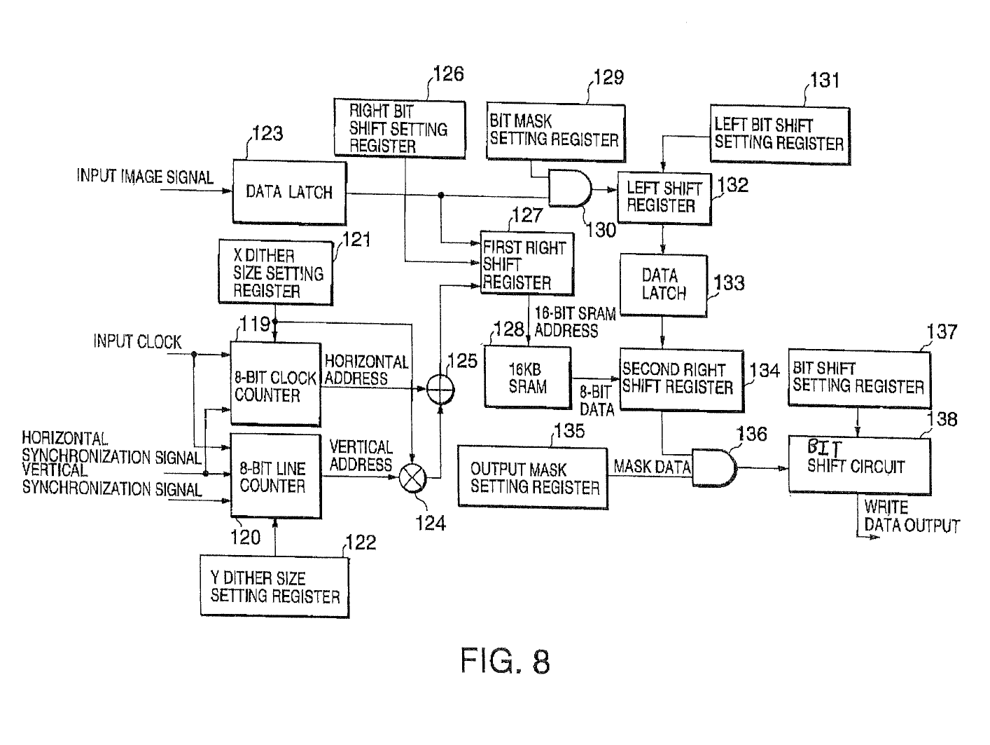

Now referring to FIG. 8, a block diagram illustrates a second preferred embodiment of the image processing circuit according to the current invention. In general, the second preferred embodiment processes multiple input signal sizes to generate multiple output signal sizes based upon a predetermined set of dithering sizes. For example, the second preferred embodiment processes an 8-bit input image signal to generate an 8-bit output signal based upon an s8×t8 dithering size (≦64). Similarly, the same preferred embodiment processes a 4-bit input image signal to generate a 4-bit output signal based upon a s4×t4 dithering size (≦128) while the same hardware also processes a 2-bit input image signal to generate a 2-bit output signal based upon a s2×t2 dithering size (≦256). It is also possible for the second preferred embodiment to process a 1-bit input image signal to generate a 1-bit output signal based upon a s1×t1 dithering size (≦512, s1≦256, t1≦256). In the above example, one dithering size is an s8×t8 (≦64), it is not limited to this size. A single memory is used to process the above various sizes of bit and dither.

Still referring to FIG. 8, the second preferred embodiment of the image processing circuit according to the current invention includes substantially identical components and units as the first preferred embodiment but also additional units or components. The second preferred embodiment further includes a 8-bit clock counter 119, a 8-bit line counter 120, a X dither size setting register 121, a Y dither size setting register 122, a data latch 123, a multiplier 124, an adder 125, a right bit shift setting register 126, a first right shift register 127, a 16 KB SRAM 128, a bit mask setting register 129, a logical AND gate 130, a left bit shift setting register 131, a left shift register 132, a data latch 133, a second right shift register 134, an output mask setting register 135, a logical AND gate 136, a bit shift setting register 137 and a bit shift circuit 138. The bit shift setting register 137 and the bit shift circuit 138 are the additional components. Except for the additional units 137 and 138, the above units 119 through 136 of the second preferred embodiment are substantially identical to the components and functions of the first preferred embodiment. For this reason, the corresponding descriptions of the above units 119 through 136 are not repeated here. The description of the second preferred embodiment is limited to the additional units 137 and 138.

In general, the bit conversion converts one bit data into another bit output. For example, the bit conversion unit of the second preferred embodiment according to the current invention converts 2^{m} bit data into 2^{k} bit data, where m=0, 1, 2 . . . n, (n≧m) and k=0, 1, 2 . . . n, (n≦k). As described above with respect to FIG. 1, in the first preferred embodiment, a single common set of hardware universally processes the image data regardless of a predetermined number of bits for writing at a print engine, and the predetermined number of bits includes 8, 4, 2 or 1. However, it is likely that a user wants to use 4-bit data rather than 8-bit data with a large-sized dither pattern. To accomplish the above, the 4-bit data is expanded to 8 bits.

Unlike the first preferred embodiment in which a process is selected based upon a number of bits in the output, the second preferred embodiment processes the input data based upon a desired number of bits in dithering data. For example, when the print engine owns 8-bit data bus and 4-bit dither size is desired, the setting register is set to generate the 4-bit output as described with respect to the first preferred embodiment in FIG. 1. Under the above setting in the second preferred embodiment, 4-bit data is outputted to the logical AND gate 136. The above4-bit data is inputted in the bit shift circuit 138, which shifts the 4-bit data by an arbitrary value that is specified in the bit shift setting register 137. For example, if a value is +4 in the bit shift setting register 137, the bit shift circuit 138 shifts the 4-bit data to the left by 4 bits. Similarly, if a value is −4 in the bit shift setting register 137, the bit shift circuit 138 shifts the 4-bit data to the right by 4 bits. Thus, if the value is +4, the bit shift circuit 138 shifts the 4-bit dither data to the left by four bits. As a result, the 4-bit dither data is expanded to 8-bit dither data that is outputted as a 8-bit image signal. Regardless of a number of bits at the output side, a process is performed based upon a plurality of bits and dither sizes, and the data size is matched to the number of bits at the output side.

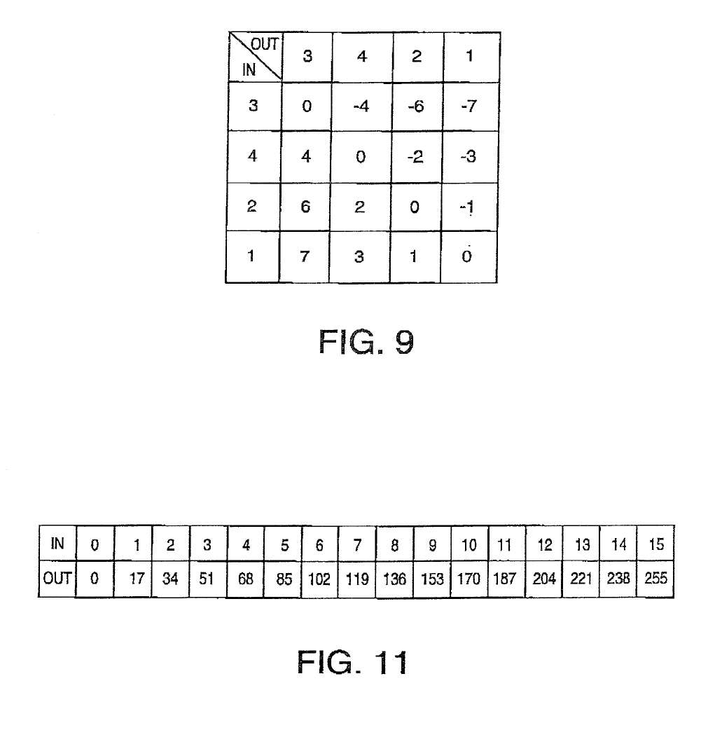

Now referring to FIG. 9, a diagram illustrates an exemplary content of a table which specifies an arbitrary value to be placed in the bit shift setting register 137 in the second preferred embodiment according to the current invention. In the table, rows indicate the input data size in a number of bits while columns indicate the output data size in a number of bits. For example, if the input data is 4-bit in size and the output data is desired to be 8-bit in size, the arbitrary value 4 as specified in the table is set in the bit shift setting register 137.

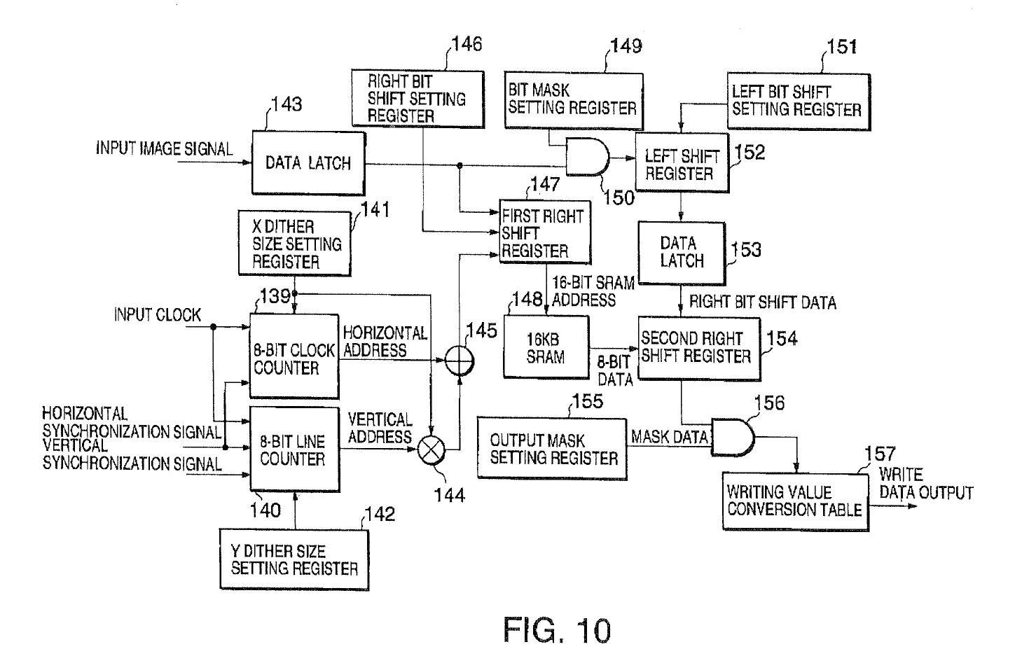

Now referring to FIG. 10, a block diagram illustrates a third preferred embodiment of the image processing circuit according to the current invention. In general, the third preferred embodiment processes multiple input signal sizes to generate multiple output signal sizes based upon a predetermined set of dithering sizes. For example, the third preferred embodiment processes an 8-bit input image signal to generate an 8-bit output signal based upon an s8×t8 dithering size (≦64). Similarly, the same preferred embodiment processes a 4-bit input image signal to generate a 4-bit output signal based upon a s4×t4 dithering size (≦128) while the same hardware also processes a 2-bit input image signal to generate a 2-bit output signal based upon a s2×t2 dithering size (≦256). It is also possible for the third preferred embodiment to process a 1-bit input image signal to generate a 1-bit output signal based upon a s1×t1 dithering size (≦512, s1≦256, t1≦256). A single memory is used to process the above various sizes of bit and dither.

Still referring to FIG. 10, the third preferred embodiment of the image processing circuit according to the current invention includes substantially identical components and units as the first and second preferred embodiments but also an additional unit or component. The third preferred embodiment further includes a 8-bit clock counter 139, a 8-bit line counter 140, a X dither size setting register 141, a Y dither size setting register 142, a data latch 143, a multiplier 144, an adder 145, a right bit shift setting register 146, a first right shift register 147, a 16 KB SRAM 148, a bit mask setting register 149, a logical AND gate 150, a left bit shift setting register 151, a left shift register 152, a data latch 153, a second right shift register 154, an output mask setting register 155, a logical AND gate 156 and a writing value conversion table 157. The bit writing value conversion table 157 is the additional component. Except for the additional unit 157, the above units 139 through 156 of the third preferred embodiment are substantially identical to the components and functions of the first and second preferred embodiments. For this reason, the corresponding descriptions of the above units 139 through 156 are not repeated here. The description of the third preferred embodiment is limited to the additional unit 157.

In general, the second preferred embodiment converts data by shifting the data and filling the lower shifted bits with zeroes. For example, when 4-bit input data such as 0×0f is expanded to 8-bit output data, the lower four bits are filled with zeroes and the 8-bit size is not fully utilized for advantage. Further more, 4-bit value output necessarily becomes 8-bit value for every sixteen values. For the above reasons, the third preferred embodiment utilizes the writing value conversion table 157 to map data to a known set of values. For example, if the data is 4-bit, every one of the possible sixteen values is mapped to a predetermined 8-bit value. The writing value conversion table 157 has a conversion precision of 8-bit to 8-bit, and any input size below the 8-bit limit is converted. In other words, regardless of the number of writing bits in a printer engine, a dither process is performed in a particular combination of the number of bits and size, and the data is finally processed to match to the writing bits of the printer engine based upon the use of the above conversion table.

Now referring to FIG. 11, a table illustrates exemplary conversion data to be used by the third preferred embodiment of the image processing according to the current invention. The table illustrates that every value of 4-bit data has a corresponding 8-bit predetermined converted value. The converted 8-bit value is a multiple of 17. Since any other 8-bit values are used as the converted 8-bit values, regardless of the number of bits at the output side, every bit is ultimately converted to a desired value.

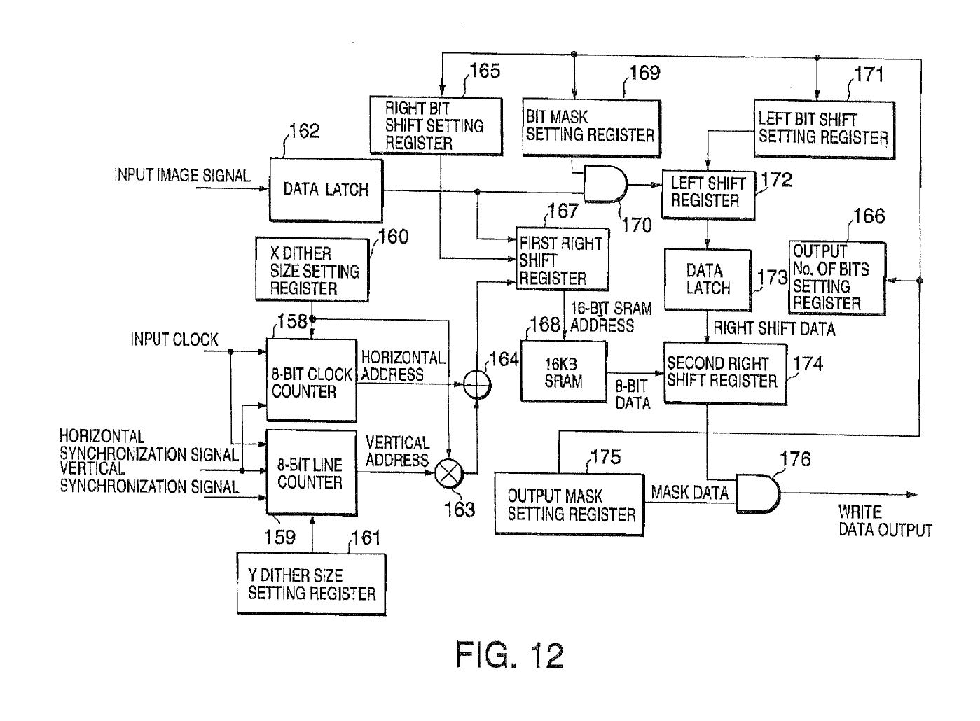

Now referring to FIG. 12, a block diagram illustrates a fourth preferred embodiment of the image processing circuit according to the current invention. In general, the fourth preferred embodiment processes multiple input signal sizes to generate multiple output signal sizes based upon a predetermined set of dithering sizes. For example, the fourth preferred embodiment processes an 8-bit input image signal to generate an 8-bit output signal based upon an s8×t8 dithering size (≦64). Similarly, the same preferred embodiment processes a 4-bit input image signal to generate a 4-bit output signal based upon a s4×t4 dithering size (≦128) while the same hardware also processes a 2-bit input image signal to generate a 2-bit output signal based upon a s2×t2 dithering size (≦256). It is also possible for the fourth preferred embodiment to process a 1-bit input image signal to generate a 1-bit output signal based upon a s1×t1 dithering size (≦512, s1≦256, t1≦256). A single memory is used to process the above various sizes of bit and dither.

Still referring to FIG. 12, the fourth preferred embodiment of the image processing circuit according to the current invention includes substantially identical components and units as the first, second or third preferred embodiments but also additional units or components. The fourth preferred embodiment further includes a 8-bit clock counter 158, a 8-bit line counter 159, a X dither size setting register 160, a Y dither size setting register 161, a data latch 162, a multiplier 163, an adder 164, a right bit shift setting circuit 165, an output no of bits setting register 166, a first right shift register 167, a 16 KB SRAM 168, a bit mask setting circuit 169, a logical AND gate 170, a left bit shift setting circuit 171, a left shift register 172, a data latch 173, a second right shift register 174, an output mask setting circuit 175 and a logical AND gate 176. Except for some units 165, 166, 169, 171 and 175, the above units 158 through 176 of the fourth preferred embodiment are substantially identical to the components and functions of the first, second and third preferred embodiments. For this reason, the corresponding descriptions of the above units are not repeated here.

The description of the fourth preferred embodiment is limited to the units 165, 166, 169, 171 and 175. Although the description is based upon an example of 4-bit data with 9×11 dither size, the fourth embodiment according to the current application is applicable to 8-bit data, 2-bit data as well as 1-bit data. According to the above example, a value, 9 is placed in the X dither size setting register 160 while a value, 11 is placed in the Y dither size setting register 161. Based upon the above values, the 8-bit clock counter 158 functions to count nine clock signals while the 8-bit line counter 159 functions to count eleven clock signals. The multiplier 163 multiplies the output from the line counter 159 by a value in the X dither size setting register 160, and the value in the above example is nine. The adder 164 adds the above product and the output from the 8-bit clock counter 158. As shown in FIG. 4, when a position in the main running direction is 5 while that in the sub running direction is 5, the result from the adder 164 and the multiplier 163 results in 50 as 5 times 9 plus 5 equals 50. The output points to a 50^{th} element in the dither matrix and is used as an offset in the SRAM 168. The 8-bit image output from the data latch 162 is placed in the lower 8 bits while the 16-bit dither matrix address offset from the adder 164 is placed in the upper 16 bits. The above combined 24-bit data is inputted into the right shift register 167. The right shift register 167 shifts the inputted data to the right by a value stored in the right bit shift setting circuit 165. By the above shift as specified in a number of bits as stored in the output no of bits setting register 166, the right bit shift setting circuit 165 outputs the following values.

| A value stored in the | The output from |
|---|---|
| output no of bits | the right shift |
| setting register 166: | register 167: |
| 8 | 0 |
| 4 | 1 |
| 2 | 2 |
| 1 | 3 |

According to the above example, since the number of bits is 4, the value of 4 is set in the output no of bits setting register 166 and the right bit shift setting circuit 165 outputs a value of 1. The right shift register 167 shifts the inputted data to the right by the value of 1. As the result, the address to the SRAM 168 is 14 bits from the 24-bit input data after the upper nine bits and the lowest bit have been removed.

Referring back to FIG. 5, as already described above, a diagram illustrates an exemplary table that stores 4-bit values according to the 256 gradations that correspond to the maximal of 128 elements in the dither matrix. At each address, 4-bit data is stored for dithering data in the SRAM 168. That is, if it is 4-bit data, there are data for two gradations at a single address. The dithering data for the two gradations is a pair of continuous two gradations. The 4-bit dither data is read from the SRAM address and is outputted into the second right shift register 174. The 4-bit dither data corresponds to the 14-bit address data from the right shift register 167. The second right shift register 174 shifts the 4-bit two-gradation dither data to the right by a number of input image data bits and output image bits. The above amount of shift is determined by masking unnecessary data after the logical AND gate 170 performs the logical AND operation on a bit mask value in the bit mask setting circuit 169 and a delay-corrected input image signal from the data latch 162. The input image signal is also inputted into the first right shift register 167.

In the bit mask setting circuit 169, one of the following values is stored depending upon a value that is set in the in the output no of bits setting register 166.

| A value stored in the | The output from |
|---|---|
| output no of bits | the bit mask setting |
| setting register 166: | circuit 169: |
| 8 | 0 x 00 |
| 4 | 0 x 01 |
| 2 | 0 x 03 |
| 1 | 0 x 07 |

For example, when the number of bits in the output no of bits setting register 166 is 4, the bit mask setting circuit 169 outputs the bit mask value is 0×01 according to the above table. Because of the above output value, the logical AND gate 170 masks the upper seven bits of the input image data with zero, and only the lowest bit is valid.

The left shift register 172 shifts the output from the logical AND gate 170 to the left by a value that is stored in the left bit shift setting circuit 171. As described above, depending upon the value in the output no of bits setting register 166, the following values are outputted to the left shift register 172 via the left bit shift setting circuit 171.

| A value stored in the | The output from |
|---|---|
| output no of bits | the left bit shift |
| setting register 166: | setting circuit 171: |
| 8 | 0 x 03 |
| 4 | 0 x 02 |
| 2 | 0 x 01 |
| 1 | 0 x 00 |

For example, when the number of bits in the output no of bits setting register 166 is 4, the left bit shift setting circuit 171 outputs the bit mask value is 0×02 according to the above table. Thus, the left shift register 172 outputs the following two output values.

| Input data | Output data |
|---|---|
| 0 x 00 | 0 x 00 |
| 0 x 01 | 0 x 04 |

Finally, the data latch 173 latches one of the above two output values, and it is outputted to the second right shift register 174. The right shift amount is thus determined for the second right shift register 174. The AND gate 176 performs the logical AND operation on the output from the second right shift register 174 and the output from the output mask setting circuit 175 in order to mask unnecessary bits. The output from the output mask setting circuit 175 also varies based upon the value in the output no of bits setting register 166.

| A value stored in the | The output from |
|---|---|
| output no of bits | the output mask |
| setting register 166: | setting circuit 175: |
| 8 | 0 x ff |
| 4 | 0 x 0f |
| 2 | 0 x 03 |
| 1 | 0 x 01 |

For example, when the number of bits in the output no of bits setting register 166 is 4, the output mask setting circuit 175 outputs the bit mask value is 0×0f according to the above table. After one of the above four outputs is latched in the data latch 173, the output is used as an amount for the right shift for the second right shift register 174. When the right shift amount is 0×00, the 4-bit two-gradation image data is outputted to the logical AND gate 176. For an 2-bit output, the setting value is 0×0f in the output mask setting circuit 175, and it masks the upper four bits to generate the 4-bit image output data. Furthermore, when the right shift amount is 0×04, the 4-bit two-gradation image data is shifted to the right by four bits, and the upper four bits are shifted to the lower bit positions. The result is outputted to the logical AND gate 176. Similarly, after the upper four bits are masked by the value, 0×0f, the 4-bit data is outputted.

As described above, by providing a register for setting a number of output bits, an amount of shift and a mask value are respectively determined for a shift register and a logical AND circuit based upon the number. The above determination enables the management of various units based upon a single register rather than a corresponding individual register. The single register management simplifies the device and shortens the parameter setting time.

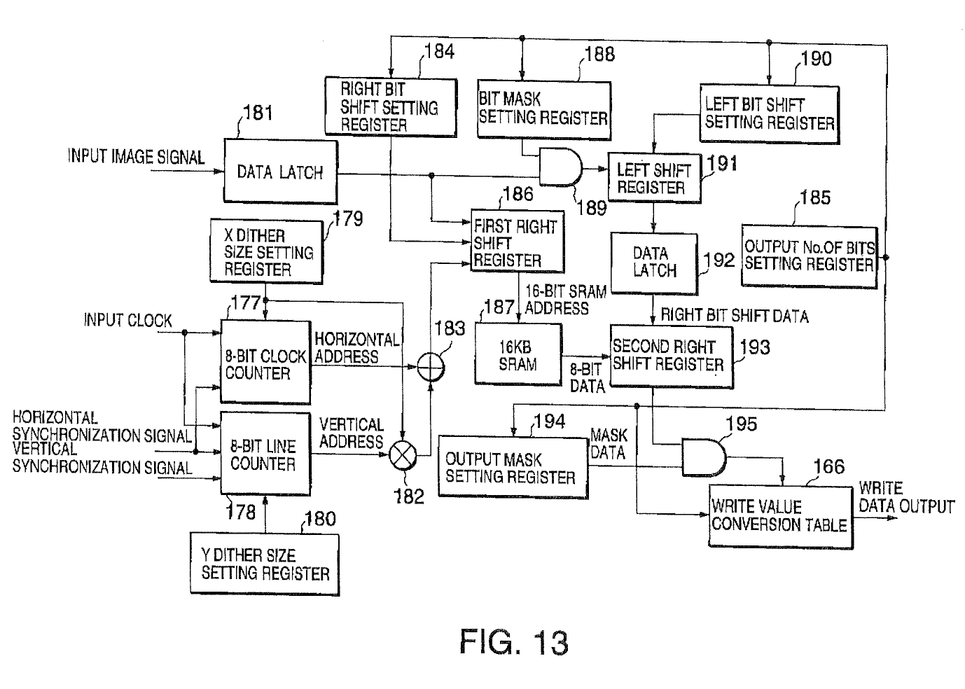

Now referring to FIG. 13, a block diagram illustrates a fifth preferred embodiment of the image processing circuit according to the current invention. In general, the fifth preferred embodiment processes multiple input signal sizes to generate multiple output signal sizes based upon a predetermined set of dithering sizes. For example, the fifth preferred embodiment processes an 8-bit input image signal to generate an 8-bit output signal based upon an s8×t8 dithering size (≦64). Similarly, the same preferred embodiment processes a 4-bit input image signal to generate a 4-bit output signal based upon a s4×t4 dithering size (≦128) while the same hardware also processes a 2-bit input image signal to generate a 2-bit output signal based upon a s2≦t2 dithering size (≦256). It is also possible for the fifth preferred embodiment to process a 1-bit input image signal to generate a 1-bit output signal based upon a s1×t1 dithering size (≦512, s1≦256, t1≦256). In the above example, one dithering size is an s8×t8 (≦64), it is not limited to this size. A single memory is used to process the above various sizes of bit and dither.

Still referring to FIG. 13, the fifth preferred embodiment of the image processing circuit according to the current invention includes substantially identical components and units as the first preferred embodiment but also additional units or components. The fifth preferred embodiment further includes a 8-bit clock counter 177, a 8-bit line counter 178, a X dither size setting register 179, a Y dither size setting register 180, a data latch 181, a multiplier 182, an adder 183, a right bit shift setting circuit 184, a the output no of bits setting register 185, a first right shift register 186, a 16KB SRAM 187, a bit mask setting circuit 188, a logical AND gate 189, a left bit shift setting circuit 190, a left shift register 191, a data latch 192, a second right shift register 193, an output mask setting circuit 194, a logical AND gate 195, and a writing value conversion table 196. Except for the additional units 185 and 196, the above units 177 through 195 of the fifth preferred embodiment are substantially identical to the components and functions of the first preferred embodiment. For this reason, the corresponding descriptions of the above units 177 through 195 are not repeated here. The description of the fifth preferred embodiment is limited to the additional units 185 and 196.

In general, the bit conversion converts one bit data into another bit output. For example, the bit conversion unit of the fifth preferred embodiment according to the current invention converts 2^{m} bit data into 2^{k} bit data, where m=0, 1, 2 . . . n, (n≧m) and k=0, 1, 2 . . . n, (n≧k) using tables. A conversion means switches among the tables based upon a setting value in the output bit number storing means. As described with respect to the fourth preferred embodiment as shown FIG. 12, a register stores a value that specifies an amount of shift in a shift register and a mask value in a logical AND circuit.

The output bit number is simply managed by single register content. Similarly, the writing value conversion table 196 stores four conversion tables for 8-bit data, 4-bit data, 2-bit data and 1-bit data. Based upon a number of bit value in the output no of bits setting register 185, one of the above conversion tables is selected. This switching method eliminates the setting of a conversion table as a number of bits is changed. Accordingly circuit initialization time is shortened.

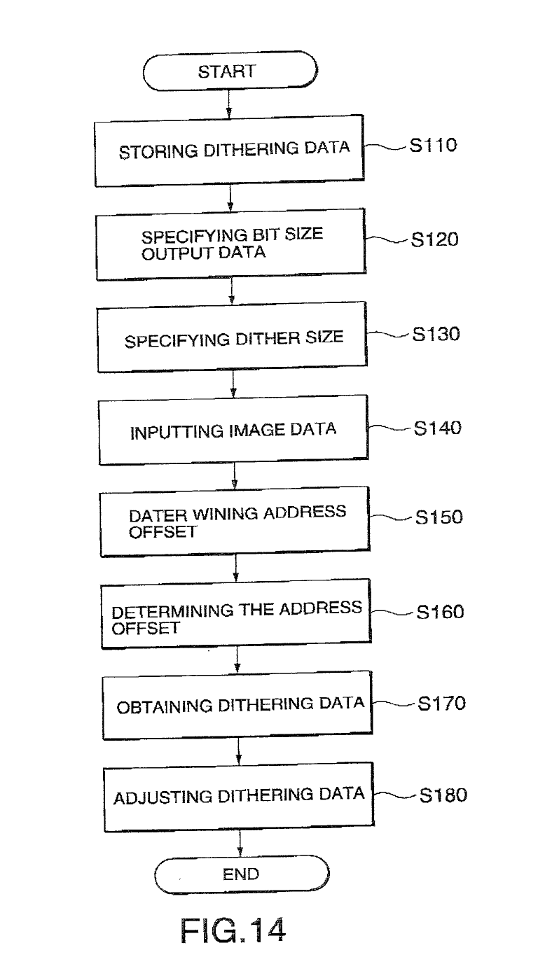

FIG. 14 is a flow chart illustrating steps involved in a preferred process of dithering image data according to the current invention. The steps in the preferred process includes a step 110 of storing dithering data in memory in a predetermined table, a step 120 of specifying an output data bit size in a number of bits per pixel for output data, and a step 130 of specifying a dither size of a dither matrix in a second number in a running direction times a third number in a sub-running direction. The dither size is independent of the output data. Additional steps further include a step 140 of inputting input image data having an input data bit size in a number of bits per pixel, a step 150 of determining an address offset into the predetermined table based upon the output data bit size and the dither size, a step 160 of adjusting the address offset based upon the output data bit size, a step 170 of obtaining a relevant portion of the dithering data from the memory based upon the address offset and a step 180 of adjusting the relevant portion of the dithering data based upon the output data bit size and the input data to generate adjusted dithering data.

Still referring to FIG. 14, the above described steps are further explained in the following. The dithering data includes a predetermine set of gradation values, and each of the gradation values has the output data bit size. The gradation values express gradual intensities and are consecutively stored at consecutive addresses in the memory. The dither matrix has a plurality of sets of the gradation values. Furthermore, the plurality of the sets of the gradation values are consecutively stored at addresses in the memory. Incidentally, the above preferred process includes an additional step of converting the adjusted dithering data in a second output data bit size in a number of bits per pixel for output data. The above additional conversion step is accomplished based upon a predetermined data at least in a single conversion table. Optionally, a plurality of conversion tables is used. The above adjustment includes shifting in a shift resigister and masking in a logical ANDing circuit.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of dithering image data, comprising the steps of:
storing dithering data in memory in a predetermined table;
specifying an output data bit size in a number of bits per pixel for output data;
specifying a dither size of a dither matrix in a second number in a running direction times a third number in a sub-running direction, the dither size being independent of the output data;
inputting input image data having an input data bit size in a number of bits per pixel;
determining an address offset into the predetermined table based upon the output data bit size and the dither size;
adjusting the address offset based upon the output data bit size;
obtaining a relevant portion of the dithering data from the memory based upon the address offset; and
adjusting the relevant portion of the dithering data based upon the output data bit size and the input data to generate adjusted dithering data.

2. The method of dithering image data according to claim 1 wherein the dithering data includes a predetermine set of gradation values, each of the gradation values having the output data bit size.

3. The method of dithering image data according to claim 1 wherein the gradation values express gradual intensities and are consecutively stored at consecutive addresses in the memory.

4. The method of dithering image data according to claim 3 wherein the dither matrix has a plurality of sets of the gradation values.

5. The method of dithering image data according to claim 4 wherein the plurality of the sets of the gradation values are consecutively stored at addresses in the memory.

6. The method of dithering image data according to claim 1 further comprising the additional step of converting the adjusted dithering data in a second output data bit size in a number of bits per pixel for output data.

7. The method of dithering image data according to claim 6 wherein said conversion is accomplished based upon a predetermined data at least in a single conversion table.

8. The method of dithering image data according to claim 7 wherein a plurality of conversion tables is used.

9. The method of dithering image data according to claim 1 wherein said adjustment includes shifting.

10. The method of dithering image data according to claim 1 wherein said adjustment includes bit shifting and masking by logical ANDing.

11. A storage medium containing computer executable instructions to perform tasks of dithering image data, comprising the tasks of:
storing dithering data in memory in a predetermined manner;
specifying an output data bit size in a number of bits per pixel for output data;
specifying a dither size of a dither matrix in a second number in a running direction times a third number in a sub-running direction, the dither size being independent of the output data;
inputting input image data having an input data bit size in a number of bits per pixel;
determining an address offset into the table based upon the output data bit size and the dither size;
adjusting the address offset based upon the output data bit size;
obtaining a relevant portion of the dithering data from the memory based upon the address offset; and
adjusting the relevant portion of the dithering data based upon the output data bit size and the input data to generate adjusted dithering data.

12. The storage medium containing computer executable instructions to perform tasks of dithering image data according to claim 1 wherein the dithering data includes a predetermine set of gradation values, each of the gradation values having the output data bit size.

13. The storage medium containing computer executable instructions to perform tasks of dithering image data according to claim 11 wherein the gradation values express gradual intensities and are consecutively stored at consecutive addresses in the memory.

14. The storage medium containing computer executable instructions to perform tasks of dithering image data according to claim 13 wherein the dither matrix has a plurality of sets of the gradation values.

15. The storage medium containing computer executable instructions to perform tasks of dithering image data according to claim 14 wherein the plurality of the sets of the gradation values are consecutively stored at addresses in the memory.

16. The storage medium containing computer executable instructions to perform tasks of dithering image data according to claim 11 further comprising the additional step of converting the adjusted dithering data in a second output data bit size in a number of bits per pixel for output data.

17. The storage medium containing computer executable instructions to perform tasks of dithering image data according to claim 16 wherein said conversion is accomplished based upon a predetermined data at least in a single conversion table.

18. The storage medium containing computer executable instructions to perform tasks of dithering image data according to claim 17 wherein a plurality of conversion tables is used.

19. The storage medium containing computer executable instructions to perform tasks of dithering image data according to claim 11 wherein said adjustment includes shifting.

20. The storage medium containing computer executable instructions to perform tasks of dithering image data according to claim 11 wherein said adjustment includes bit shifting and masking by logical ANDing.

21. An image processing device for dithering image data, comprising:
a data storage unit for storing dithering data in memory in a predetermined manner;
a first temporary memory unit for specifying an output data bit size in a number of bits per pixel for output data;
a second temporary memory unit for specifying a dither size of a dither matrix in a second number in a running direction times a third number in a sub-running direction, the dither size being independent of the output data;
a third temporary memory unit operationally connected to said second temporary memory unit for inputting input image data having an input data bit size in a number of bits per pixel;
an address offset determination unit operationally connected to said data storage unit and for determining an address offset into the table based upon the output data bit size and the dither size, said address offset determination unit adjusting the address offset based upon the output data bit size; and
a dithering data selection unit operationally connected to said first temporary memory unit, said third temporary memory unit, said address offset determination unit and said data storage unit for obtaining a relevant portion of the dithering data from the memory based upon the address offset, said dithering data selection unit adjusting the relevant portion of the dithering data based upon the output data bit size and the input data to generate adjusted dithering data.

22. The image processing device for dithering image data according to claim 21 wherein said data storage unit stores the dithering data including a predetermine set of gradation values, each of the gradation values having the output data bit size.

23. The image processing device for dithering image data according to claim 21 wherein said data storage unit stores the gradation values that expresses gradual intensities and are consecutively stored at consecutive addresses in the memory.

24. The image processing device for dithering image data according to claim 23 wherein said data storage unit stores the dither matrix that has a plurality of sets of the gradation values.

25. The image processing device for dithering image data according to claim 24 wherein said data storage unit stores the plurality of the sets of the gradation values in a consecutive manner in the memory.

26. The image processing device for dithering image data according to claim 21 further comprising a writing value conversion unit connected to said dithering data selection unit for converting the adjusted dithering data in a second output data bit size in a number of bits per pixel for output data.

27. The image processing device for dithering image data according to claim 26 wherein said writing value conversion unit includes a predetermined data at least in a single conversion table.

28. The image processing device for dithering image data according to claim 27 wherein said writing value conversion unit includes a plurality of conversion tables is used.

29. The image processing device for dithering image data according to claim 21 wherein said dithering data selection unit includes a shift register for shifting the relevant portion of the dithering data.

30. The image processing device for dithering image data according to claim 21 wherein said dithering data selection unit includes a logical AND gate for masking the relevant portion of the dithering data with a predetermined value corresponding to the output data bit size.

31. The image processing device for dithering image data according to claim 21 wherein said dithering data selection unit includes a logical AND gate for masking the input image data with a predetermined value corresponding to the output data bit size.
